(19) United States
(12) Patent Application Publication
(10) Pub. No.: US 2026/0275775 A1
(43) Pub. Date: Sep. 17, 2026

(54) VEHICLE DOOR DEVICE

(71) Applicant: AISIN CORPORATION, Kariya (JP)

(72) Inventors: Hiroyuki HASEGAWA, Kariya-shi (JP); Satoshi TAKENO, Kariya-shi (JP); Yasuhiro NAGAYA, Kariya-shi (JP); Syota NAKANO, Kariya-shi (JP)

(73) Assignee: AISIN CORPORATION, Kariya (JP)

(21) Appl. No.: 19/560,544

(22) Filed: Mar. 9, 2026

(30) Foreign Application Priority Data
Mar. 14, 2025 (JP) 2025-041705
Jan. 6, 2026 (JP) 2026-000812

(51) Int. Cl. E05B 77/26; E05B 77/30

(52) U.S. Cl. CPC E05B 77/265; E05B 77/30

(57) ABSTRACT

A vehicle door device mechanically connected to inside and outside handles of vehicle door, vehicle door device including locking operating member configured to be movable between on-and off-positions, door latch mechanism mechanically connected to inside and outside handles, locking operating member, and door lock mechanism mechanically connected to inside handle and to selectively forms first door locked state when locking operating member is at off-position and second door locked state when locking operating member is at on-position, wherein door latch mechanism includes first mechanism to open door latch on basis of series of two door opening operations by inside handle in first door locked state, and second mechanism configured to disable door opening operation by inside handle in second door locked state, and door lock mechanism includes third mechanism to form unlocked state of door on basis of door opening operation by inside handle in second door locked state.

### CROSS REFERENCE TO RELATED APPLICATIONS

This application is based on and claims priority under 35 U.S.C. § 119 to Japanese Patent Application No. 2026-000812, filed on Jan. 6, 2026 and Japanese Patent Application No. 2025-041705, filed on Mar. 14, 2025, the entire content of which is incorporated herein by reference.

### TECHNICAL FIELD

The present disclosure relates to a vehicle door device mechanically connected to an inside handle and an outside handle of a vehicle door.

### BACKGROUND DISCUSSION

In this type of vehicle door device, a so-called double-pull structure is known in which a door latch is opened on the basis of a series of two door opening operations by an inside handle in a locked state of a door. In the double-pull structure, when the door opening operation by the inside handle is performed once from the locked state of the door, the door shifts to an unlocked state. Then, when the door opening operation by the inside handle is performed again (second time) from this state, the door latch is opened and the door can be opened.

Meanwhile, in such a double-pull structure, it is possible to mount an operation disabling mechanism (a mechanism that disables the door opening operation by the inside handle) such as a child lock mechanism as in the conventional technique described above (for example, U.S. Patent Application Publication No. 2017/0314297A).

However, in the conventional technique described above, when the operation disabling mechanism is turned on (the disabled state of the door opening operation by the inside handle is formed), the door is brought into a state where the unlocked state of the door is not formed no matter how many times the door opening operation by the inside handle is performed in the locked state of the door. As a result, this causes a problem that it is difficult to open the door in an emergency involving a power supply failure. That is, at the time of the power supply failure, the door cannot be opened, which is inconvenient.

Therefore, in one aspect, an object of the present disclosure is to enable formation of an unlocked state on the basis of a door opening operation by an inside handle even at the time of a power supply failure and even in an on-state of an operation disabling mechanism while adopting a double-pull structure.

A need thus exists for a vehicle door device which is not susceptible to the drawback mentioned above.

### SUMMARY

In one aspect, there is provided a vehicle door device mechanically connected to an inside handle and an outside handle of a vehicle door, the vehicle door device including:
a locking operating member configured to be movable between an on-position and an off-position;
a door latch mechanism mechanically connected to the inside handle, the outside handle, and the locking operating member; and
a door lock mechanism mechanically connected to the inside handle and configured to be able to selectively form a first door locked state when the locking operating member is at the off-position and a second door locked state when the locking operating member is at the on-position, in which
the door latch mechanism includes
a first mechanism configured to open a door latch on a basis of a series of two door opening operations by the inside handle in the first door locked state, and
a second mechanism configured to disable a door opening operation by the inside handle in the second door locked state, and
the door lock mechanism includes a third mechanism configured to form an unlocked state of a door on a basis of a door opening operation by the inside handle in the second door locked state.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a view illustrating an example of a vehicle on which a door lock device according to the present embodiment is mounted;

FIG. 2 is a schematic diagram illustrating an example of a control system of the door lock device;

FIG. 3 is a perspective view of a schematic configuration of a door latch device according to the present embodiment as viewed from a vehicle interior side;

FIG. 4 is a perspective view of the schematic configuration of the door latch device as viewed from a vehicle exterior side;

FIG. 5 is an explanatory view (part 1) of a double-pull mechanism of a door latch mechanism, and is a plan view as viewed from a vehicle exterior side;

FIG. 5A is a view illustrating the state of FIG. 5 in plan view from below;

FIG. 6 is an explanatory view (part 2) of the double-pull mechanism of the door latch mechanism, and is a plan view as viewed from the vehicle exterior side;

FIG. 6A is a view illustrating the state of FIG. 6 in plan view from below;

FIG. 7 is an explanatory view (part 3) of the double-pull mechanism of the door latch mechanism, and is a plan view as viewed from the vehicle exterior side;

FIG. 8 is an explanatory view (part 4) of the double-pull mechanism of the door latch mechanism, and is a plan view as viewed from the vehicle exterior side;

FIG. 9 is an explanatory view (part 1) of a child protection mechanism of the door latch mechanism, and is a plan view as viewed from the vehicle exterior side;

FIG. 10 is an explanatory view (part 2) of the child protection mechanism of the door latch mechanism, and is a plan view as viewed from the vehicle exterior side;

FIG. 11 is an explanatory view (part 1) of an emergency unlock mechanism of a door lock mechanism, and is a plan view as viewed from the vehicle exterior side;

FIG. 12 is an explanatory view (part 2) of the emergency unlock mechanism of the door lock mechanism, and is a plan view as viewed from the vehicle exterior side;

FIG. 13 is an explanatory view (part 3) of the emergency unlock mechanism of the door lock mechanism, and is a plan view as viewed from the vehicle exterior side;

FIG. 14 is an explanatory view (part 4) of the emergency unlock mechanism of the door lock mechanism, and is a plan view as viewed from the vehicle exterior side;

FIG. 15 is a view illustrating a door latch device according to a second embodiment, and is a plan view as viewed from the vehicle interior side;

FIG. 16 is a perspective view illustrating a relationship between a lock knob and an actuator lever in the door latch device according to the second embodiment;

FIG. 17 is an explanatory view illustrating the door latch device according to the second embodiment, and is a plan view of a locked state as viewed from the vehicle exterior side; and

FIG. 18 is an explanatory view illustrating the door latch device according to the second embodiment, and is a plan view of an unlocked state as viewed from the vehicle exterior side.

### DETAILED DESCRIPTION

Hereinafter, each embodiment will be described in detail with reference to the accompanying drawings. Note that the dimensional ratios in the drawings are merely examples, and the dimensional ratios are not limited thereto, and shapes and the like in the drawings may be partially exaggerated for convenience of description. In addition, in the drawings, only some of a plurality of portions having the same attribute may be denoted by reference numerals for the sake of clarity.

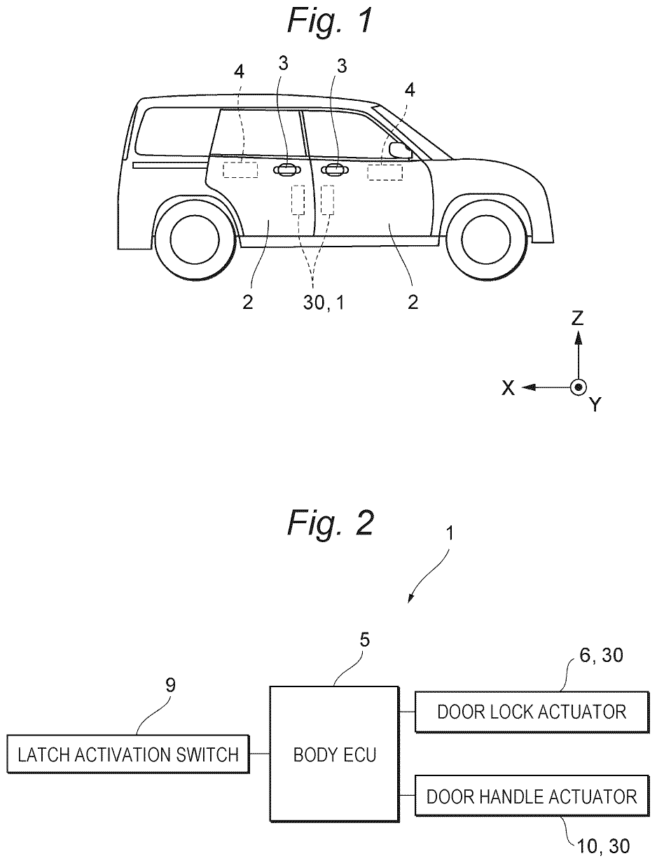

FIG. 1 is a view illustrating an example of a vehicle on which a door lock device 1 according to the present embodiment is mounted. Note that the configurations of the door lock devices 1 on the left and right sides of the vehicle may be symmetrical.

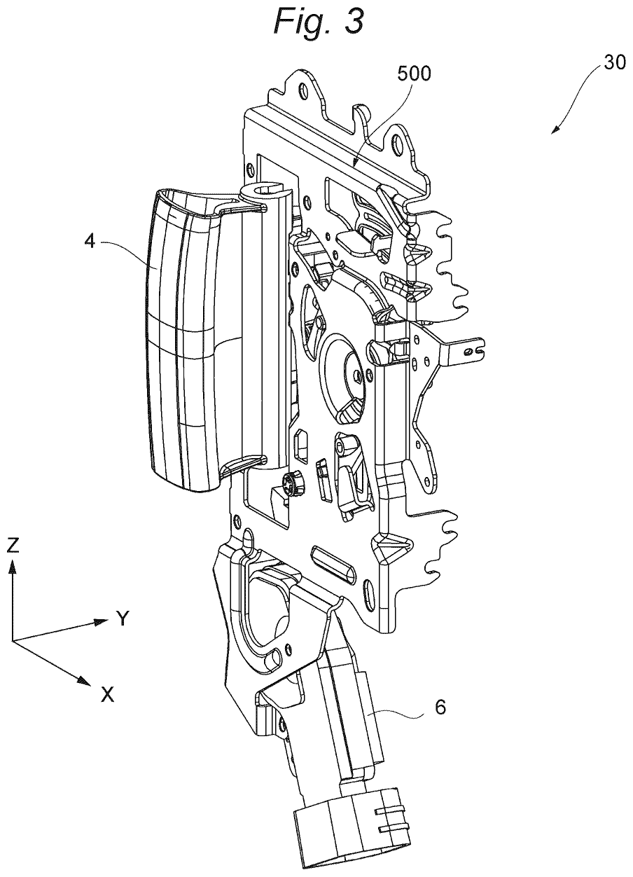

In FIG. 1 (and FIGS. 3 to 14 to be described later), X, Y, and Z axes, which are three axes orthogonal to each other in a right-handed coordinate system, are illustrated. Here, it is assumed that the Y direction corresponds to a vehicle width direction, and the positive side is a vehicle outer side. The X direction corresponds to a vehicle front-rear direction, and the positive side in the X direction is a rear side. The Z direction corresponds to an up-down direction. However, in practice, the vehicle width direction, the vehicle front-rear direction, and/or the vertical direction (the gravity direction) may be slightly inclined with respect to the X direction, the Y direction, and the Z direction (for example, by less than 20 degrees). That is, the X direction, the Y direction, and the Z direction only need to have main direction components of the vehicle front-rear direction, the vehicle width direction, and the vertical direction (the gravity direction), respectively.

The door lock device 1 is incorporated in a door of the vehicle. That is, the door lock device 1 is mainly provided between a door outer panel 2 and a door inner panel (not illustrated) of the vehicle. Note that the door of the vehicle in which the door lock device is incorporated may be any door or may be all doors except a back door. In addition, the door opening and closing system may also be any system, and a sliding door, a door that opens and closes by rotating around a vertical axis, or the like may be used.

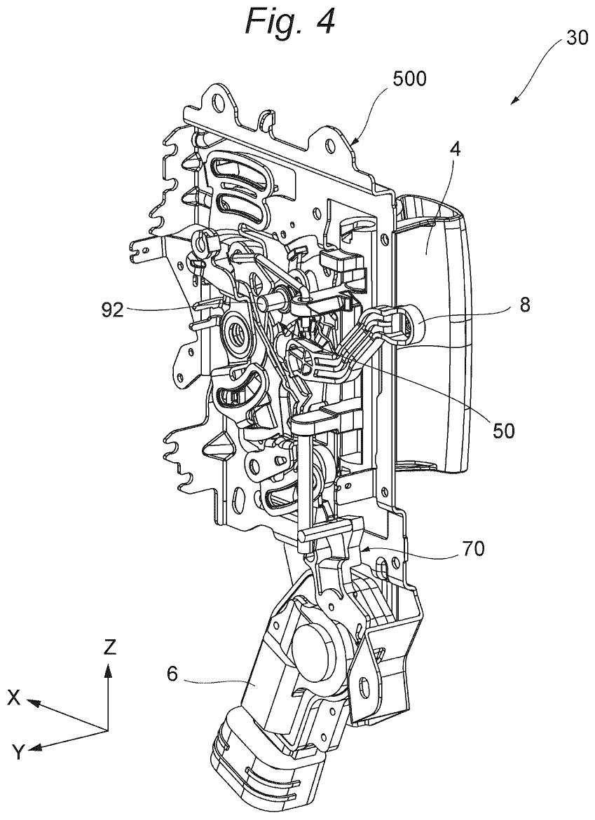

The door lock device 1 includes a door outside handle 3, a door inside handle 4, and a child lock lever 8 (see FIG. 4 and the like).

The door outside handle 3 is a member that can be operated outside the vehicle, and is provided so as to be exposed from the door outer panel 2 to the outside of the vehicle. The door outside handle 3 may be any handle, but may be, for example, a handle of a normal manually drawn type or a handle of a pop-up type. In the case of the pop-up type, in an initial state, the handle is retracted (stored) along the surface of the door outer panel 2. For example, the door outside handle 3 is stored inside the door (on the negative side in the Y direction of the door outer panel 2) such that the surface on the positive side in the Y direction (the vehicle outer side) is substantially continuous with the surface of the door outer panel 2.

The door inside handle 4 is a member that can be operated in a vehicle interior, and is provided so as to be exposed in the vehicle interior. The child lock lever 8 is a member that can be operated in a door open state, and is provided to be inoperable in a door closed state. For example, the child lock lever 8 may be provided on a door side surface (a surface facing a peeler in the door closed state).

The door lock device 1 includes a door latch device 30.

The door latch device 30 is mechanically connected to the door outside handle 3 and the door inside handle 4. The door latch device 30 operates in response to a user input or the like via the door outside handle 3 or the door inside handle 4 to switch between a locked state and an unlocked state of the door. Furthermore, in response to an instruction from a body electronic control unit (ECU) 5 (see FIG. 2), the door latch device 30 operates a door lock actuator 6 (see FIG. 2) to switch between the locked state and the unlocked state of the door. Hereinafter, the switching from the locked state to the unlocked state by the operation of the door lock actuator 6 is also referred to as “electric latch activation”.

In the following description, the door opening operation from the vehicle interior means a manual operation on the door inside handle 4. Specifically, the door inside handle 4 is supported by the door in such a manner that the state of the door inside handle 4 can be changed between an initial state and a state where the door inside handle 4 is pulled to an effective position by a pulling operation (hereinafter, also referred to as “pulled state”). The door opening operation from the vehicle interior means an operation from the initial state to the pulled state unless otherwise specified.

FIG. 2 is a schematic diagram illustrating an example of a control system of the door lock device 1.

The control system of the door lock device 1 is configured around the body ECU 5. The body ECU 5 is formed by a computer and the like. Note that the body ECU 5 may have a function of controlling various in-vehicle devices (for example, a power window, an electric seat, and the like) other than the door lock device 1.

The door lock actuator 6, a latch activation switch 9, and a door handle actuator 10 are connected to the body ECU 5.

When the door lock operating condition is satisfied, the body ECU 5 drives the door lock actuator 6 to operate the door latch device 30. Any door lock operating condition may be adopted. In the present embodiment, the door lock operating condition related to the switching of the door from the locked state to the unlocked state is satisfied when the latch activation switch 9 is turned on from an off-state (an initial state).

Furthermore, in the case of the pop-up type, when the door handle operating condition is satisfied, the body ECU 5 drives the door handle actuator 10 to operate the door outside handle 3. Although any door handle operating condition may be adopted, in the present embodiment, the door handle operating condition may be a condition related to the switching of the door outside handle 3 from an initial state to a pop-up state, for example, as follows. That is, the door handle operating condition may be satisfied in a case where a valid user approaches the vehicle or the valid user touches a predetermined portion of the door outside handle 3. In this case, the valid user is a user who possesses an electronic key that transmits a radio wave including a valid identifier, and may be detected by the body ECU 5 via communication between an in-vehicle antenna (not illustrated) and the electronic key.

FIG. 3 is a perspective view of a schematic configuration of the door latch device 30 of the present embodiment as viewed from a vehicle interior side, and FIG. 4 is a perspective view of the schematic configuration of the door latch device 30 as viewed from a vehicle exterior side.

In FIGS. 3 and 4, the door outside handle 3 is not illustrated.

The door latch device 30 of the present embodiment includes the door lock actuator 6, a door latch mechanism 50, and a door lock mechanism 70. Note that the door latch mechanism 50 and the door lock mechanism 70 may include common members. That is, a certain member may form the door lock mechanism 70 as well as the door latch mechanism 50.

The door latch mechanism 50 is mechanically connected to the door outside handle 3 (see FIG. 1), the door inside handle 4, and the child lock lever 8. The child lock lever 8 is an operation device for moving a child protection pin 92 (to be described later) in the door latch mechanism 50 between an initial position and an operating position.

Note that in the present embodiment, the child lock lever 8 is in the form of a lever, but may be in another form (for example, in the form of a linearly movable member). The child lock lever 8 is an operating member for preventing the door from being opened by a careless operation (an unintended operation) from the vehicle interior. The child lock lever 8 is movable between an on-position where the door opening operation from the vehicle interior is disabled and an off-position where the door opening operation from the vehicle interior is enabled. In a case where a user desires to disable the door opening operation from the vehicle interior, the user can move the child lock lever 8 to the on-position. As a result, it is possible to prevent a child or the like from opening the door from the vehicle interior while the vehicle is traveling. Details of the function of the door latch mechanism 50 will be described later.

The door lock mechanism 70 is mechanically connected to the door inside handle 4. The door lock mechanism 70 selectively forms the locked state and the unlocked state of the door. Note that the door lock mechanism 70 can form the locked state of the door regardless of whether or not the child lock lever 8 is in the on-position. Hereinafter, for the sake of description, the locked state of the door when the child lock lever 8 is in the off-position is also referred to as “normal locked state (an example of a first door locked state)”, and the locked state of the door when the child lock lever 8 is in the on-position is also referred to as “locked state at the time of disabling-on (an example of a second door locked state)” for the purpose of distinction. Note that the normal locked state and the locked state at the time of disabling-on are states formed depending on the position of the child lock lever 8, only one of them is selectively formed. Details of the door lock mechanism 70 will be described later.

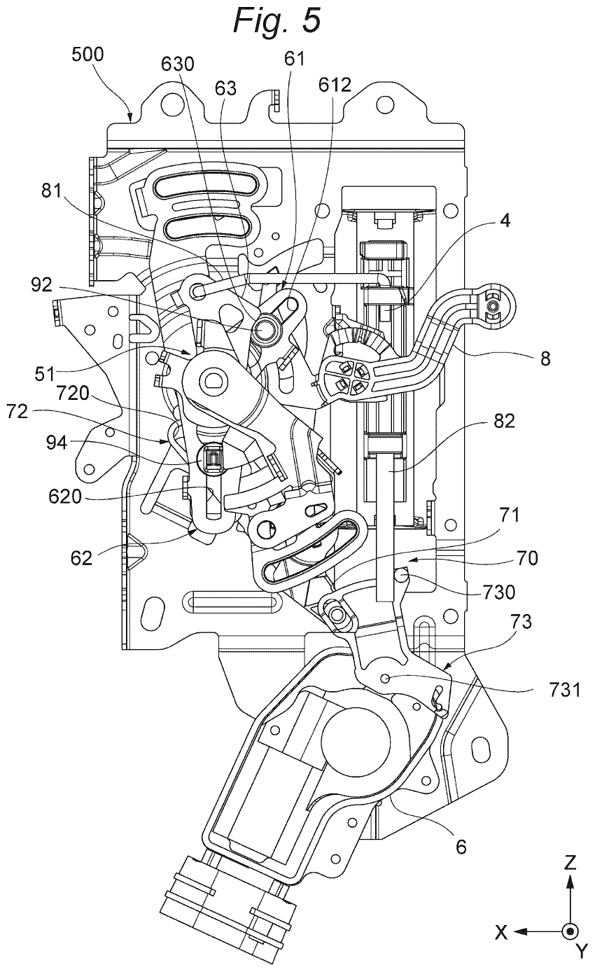

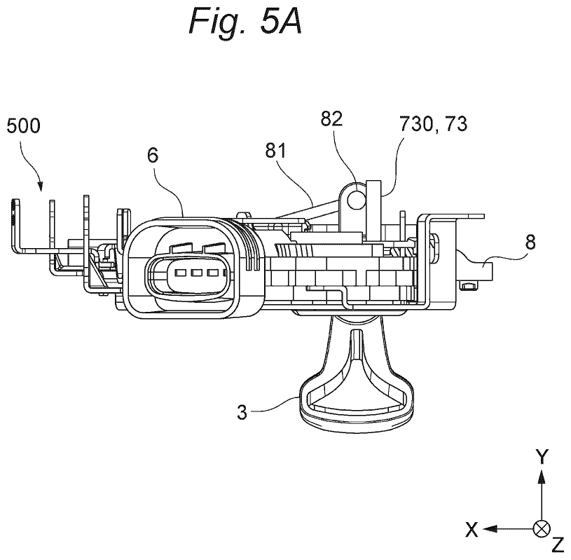

FIGS. 5 to 8 are explanatory views of a double-pull mechanism 51 of the door latch mechanism 50, and are plan views as viewed from the vehicle exterior side. Note that, in the following description, the name of each member is a name for description, and the name itself does not include a limiting meaning. The name of each member may be referred to as a different name depending on a vehicle type or the like.

The door latch mechanism 50 is fixed to a vehicle body via a support member 500. Hereinafter, in the description of each member of the door latch mechanism 50, “supported” means being directly or indirectly supported by the support member 500. Note that the support member 500 may be a one-piece member, or may be formed by a combination (integrated combination) of a plurality of pieces of members.

The door latch mechanism 50 includes the double-pull mechanism 51. The double-pull mechanism 51 functions in the normal locked state. Note that, in the normal locked state, the child lock lever 8 is at the off-position, and the child protection pin 92 is at the initial position.

Specifically, the double-pull mechanism 51 opens a door latch (not illustrated) on the basis of a series of two door opening operations by the door inside handle 4 in the normal locked state. Note that the door latch is a component of the door latch mechanism 50, and is a member that is engaged with a striker (not illustrated) on a vehicle body side to form a door closed state, and is disengaged from the striker to form a door open state.

Here, the series of two door opening operations refers to an operation mode in which no special other operation (excluding an operation of returning the door inside handle 4) or special control is performed between the two door opening operations. Specifically, as described above, the first door opening operation is an operation of bringing the door inside handle 4 in the initial state into the pulled state. Note that the door inside handle 4 is biased by a spring (not illustrated) so as to return to the initial state in a state where the force for maintaining the door inside handle 4 in the pulled state is not applied. The second door opening operation is an operation of bringing the door inside handle 4 in the initial state into the pulled state subsequent to the first door opening operation. Note that an operation of returning the door inside handle 4 in the pulled state to the initial state (hereinafter, also referred to as “returning operation”) is performed between the first door opening operation and the second door opening operation. The same returning operation is performed after the second door opening operation. Such a returning operation can be regarded as part of the series of two door opening operations.

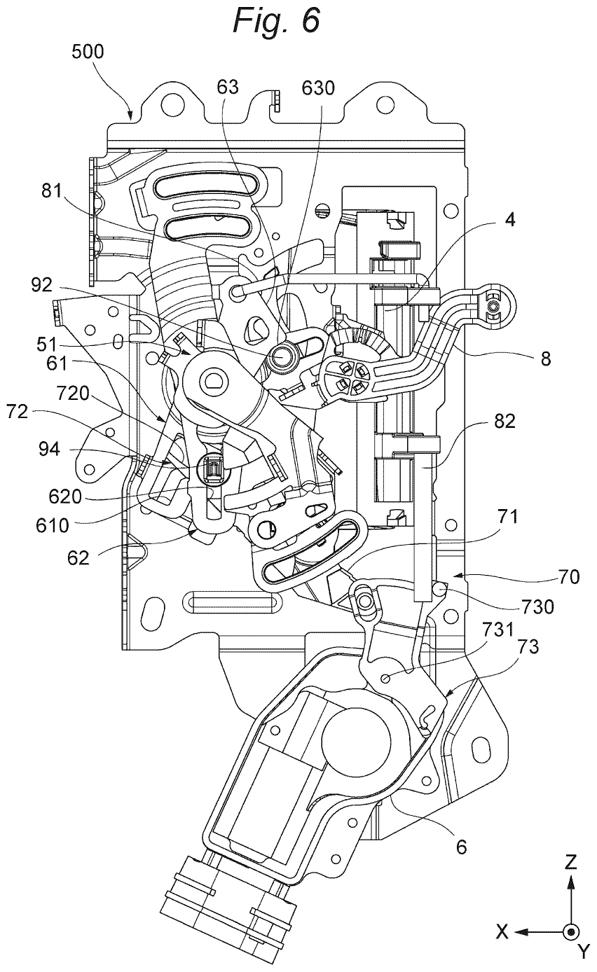

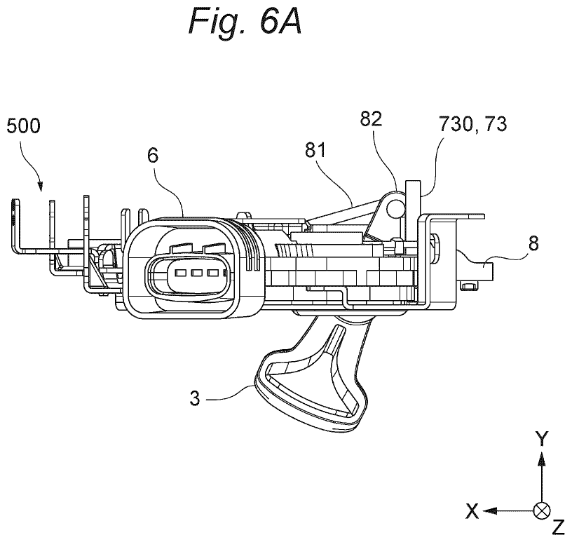

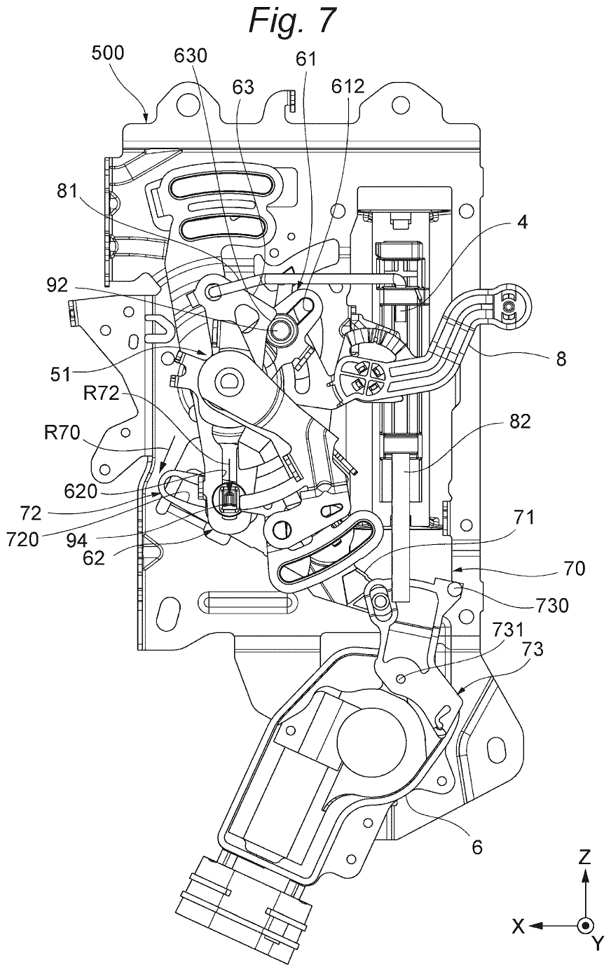

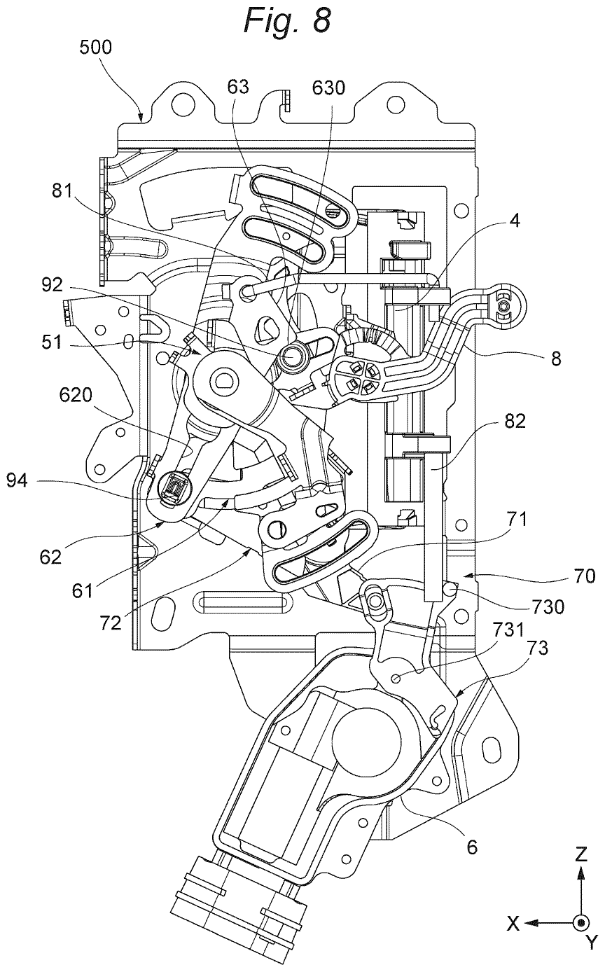

In FIGS. 5 to 8, FIG. 5 illustrates the initial state of the door inside handle 4 in the normal locked state, and FIG. 6 illustrates a state shifted from the state of FIG. 5, in which the first door opening operation has been performed (the pulled state of the door inside handle 4). FIG. 5A is a view illustrating the state of FIG. 5 in plan view from below, and FIG. 6A is a view illustrating the state of FIG. 6 in plan view from below. FIG. 7 illustrates a state shifted from the state of FIG. 6, which is an initial state where the door inside handle 4 is returned from the pulled state of FIG. 6. FIG. 8 illustrates a state shifted from the state of FIG. 7, in which the second door opening operation is completed (the pulled state of the door inside handle 4).

The double-pull mechanism 51 includes a first lever 61, a second lever 62, a third lever 63, a first panic lever 71, a second panic lever 72, and an actuator lever 73. Each of the first lever 61, the second lever 62, the third lever 63, the first panic lever 71, the second panic lever 72, and the actuator lever 73 is rotatably supported about a rotation axis in the Y direction.

The first lever 61 has a locking pin hole 610 through which the locking pin 94 passes. The locking pin hole 610 has a form of a long hole (a form as viewed in the Y direction) in which the locking pin 94 is movable, and has a lost motion portion (a portion not visible in the drawing) in a direction intersecting the longitudinal direction of the long hole.

The second lever 62 has a common rotation axis with the first lever 61. The second lever 62 is provided on the vehicle outer side with respect to the first lever 61.

The second lever 62 has a locking pin hole 620 through which the locking pin 94 passes. The locking pin hole 620 has a form of a long hole (a form as viewed in the Y direction) in which the locking pin 94 is movable. The second lever 62 is coupled to a latch (not illustrated). When the second lever 62 rotates from the initial position to the operating position, the latch is opened.

The third lever 63 has a common rotation axis with the first lever 61. The third lever 63 is provided on the vehicle outer side with respect to the second lever 62.

The third lever 63 is coupled to an open link 81. When rotating to the operating position, the third lever 63 can be engaged with the child protection pin 92 to rotate the first lever 61 via the child protection pin 92. Specifically, the third lever 63 has an engaging portion 630 that is engaged with the child protection pin 92 at the initial position. When the child protection pin 92 is at the operating position, the engaging portion 630 is not engaged with the child protection pin 92 when rotating to the operating position.

One end of the first panic lever 71 is engaged with the actuator lever 73, and the other end is pivotally supported by the support member 500.

The second panic lever 72 is provided on the vehicle inner side with respect to the first lever 61. One end is engaged with the locking pin 94, and the other end is pivotally supported by the support member 500 together with the first panic lever 71. The second panic lever 72 has a locking pin hole 720 through which the locking pin 94 passes.

In this manner, the locking pin 94 is provided so as to pass through the locking pin hole 720 of the second panic lever 72, the locking pin hole 620 of the second lever 62, and the locking pin hole 610 of the first lever 61 in the Y direction.

When the locking pin 94 is at a link cut position (an example of a first position) of the locking pin hole 620 of the second lever 62 (FIG. 5 and the like), the locked state is formed, and when the locking pin 94 is at a link position (an example of a second position) of the locking pin hole 620 of the second lever 62 (FIG. 7 and the like), the unlocked state is formed.

The actuator lever 73 is supported by the door lock actuator 6 so as to be rotatable about a rotation shaft 731. The actuator lever 73 is rotated by the operation of the door lock actuator 6. The actuator lever 73 moves the locking pin 94 between the link position and the link cut position via the first panic lever 71 and the second panic lever 72. In addition, the actuator lever 73 has an engagement pin 730 that is engaged with a transmission link 82 as described later, and is rotated on the basis of the force from the transmission link 82.

The linked movement of each lever will be described later in relation to the movement of the double-pull mechanism 51.

The double-pull mechanism 51 further includes the open link 81 and the transmission link 82.

One end of the open link 81 is coupled to the door inside handle 4, and the other end is coupled to the third lever 63. The open link 81 rotates the third lever 63 from the initial position (FIG. 5) to the operating position (the position on the side in which the latch is opened) (FIG. 6) in conjunction with the movement of the door inside handle 4 (that is, the movement from the initial state to the pulled state) at the time of the door opening operation. Furthermore, the open link 81 returns the third lever 63 from the operating position to the initial position in conjunction with the movement of the door inside handle 4 from the pulled state to the initial state.

One end of the transmission link 82 is coupled to the door inside handle 4, and the other end is engaged with the actuator lever 73. The transmission link 82 is typically a separate member from the open link 81, and in the illustrated example, the transmission link 82 is coupled to a position offset downward from the coupling position of the open link 81 (the coupling position on the door inside handle 4 side).

The transmission link 82 rotates the actuator lever 73 from the initial position (FIG. 5) to the operating position (FIG. 6) in conjunction with the movement of the door inside handle 4 (that is, the movement from the initial state to the pulled state) at the time of the door opening operation. The transmission link 82 returns to the original state in conjunction with the movement of the door inside handle 4 from the pulled state to the initial state. Here, the transmission link 82 does not act on the actuator lever 73 when returning to the original state. That is, the actuator lever 73 rotates from the initial position (FIG. 5) to the operating position (FIG. 6) by the transmission link 82 on the basis of the movement of the door inside handle 4 from the initial state to the pulled state, but remains at the operating position (FIG. 6) without being in conjunction with the movement of the door inside handle 4 from the pulled state to the initial state.

As described above, in the present embodiment, the door latch mechanism 50 has two force transmission paths from the door inside handle 4. That is, the two power transmission paths are a transmission path from the open link 81 and a transmission path from the transmission link 82.

The double-pull mechanism 51 cooperates with the door lock mechanism 70, and shifts the locked state of the door to the unlocked state on the basis of the first door opening operation (and the returning operation inevitably following the first door opening operation) in the series of two door opening operations.

Specifically, first, in the state illustrated in FIGS. 5 and 5A (the initial state of the door inside handle 4 in the normal locked state), the door inside handle 4 is pulled to the pulled state (see FIG. 6A) by the first door opening operation. At this time, in the transmission path from the open link 81, the force is transmitted to the open link 81, the third lever 63, the child protection pin 92 (to be described later), and the first lever 61 in this order, and the first lever 61 reaches the operating position. On the other hand, in the transmission path from the transmission link 82, the force is transmitted to the transmission link 82, the actuator lever 73, and the first panic lever 71 in this order, and only the first panic lever 71 reaches the link position. At this time, the locking pin 94 remains at the link cut position due to the lost motion portion of the first lever 61. For this reason, even when the first lever 61 reaches the operating position, the second lever 62 does not rotate to the operating position, and the door latch is not opened. That is, the second lever 62 remains in an inoperable state.

When the door inside handle 4 pulled to the pulled state by the first door opening operation is returned to the original initial state (that is, when the returning operation is performed), the first lever 61 returns to the original initial position. At this time, the longitudinal directions of the locking pin hole 610 of the first lever 61 and the locking pin hole 620 of the second lever 62 match each other. That is, the locking pin hole 610 of the first lever 61 and the locking pin hole 620 of the second lever 62 overlap each other as viewed in the Y direction. As a result, the locking pin 94 moves to the link position (see an arrow R72 in FIG. 7) while the second panic lever 72 rotates (see an arrow R70 in FIG. 7). Note that, when the transmission link 82 returns to the original initial position, the actuator lever 73 does not receive the transmission of the force from the transmission link 82 and is maintained in the state (the state illustrated in FIG. 6).

The door inside handle 4 is then pulled to the pulled state (see FIG. 6A) as the second door opening operation. In this case, the door latch is opened since the door inside handle 4 is pulled to the pulled state in the unlocked state. Specifically, the force is transmitted to the open link 81, the third lever 63, the child protection pin 92, the first lever 61, the locking pin 94, and the second lever 62 in this order, and the second lever 62 rotates to the operating position.

Note that when the second door opening operation is completed (see FIG. 8) and the door inside handle 4 pulled to the pulled state is returned to the original initial state (that is, when the returning operation is performed), the door inside handle 4 returns to the initial state similar to the initial state (the unlocked state of the door) illustrated in FIG. 7. Thereafter, when the door lock actuator 6 is operated, the normal locked state illustrated in FIG. 5 is formed.

In this manner, the double-pull mechanism 51 achieves a double-pull function in cooperation with the child protection pin 92 and the locking pin 94. That is, the double-pull mechanism 51 opens a door latch (not illustrated) on the basis of a series of two door opening operations by the door inside handle 4 in the normal locked state.

The door latch mechanism 50 includes a child protection mechanism 52 in addition to the double-pull mechanism 51.

The child protection mechanism 52 disables the door opening operation by the door inside handle 4 in the locked state at the time of disabling-on.

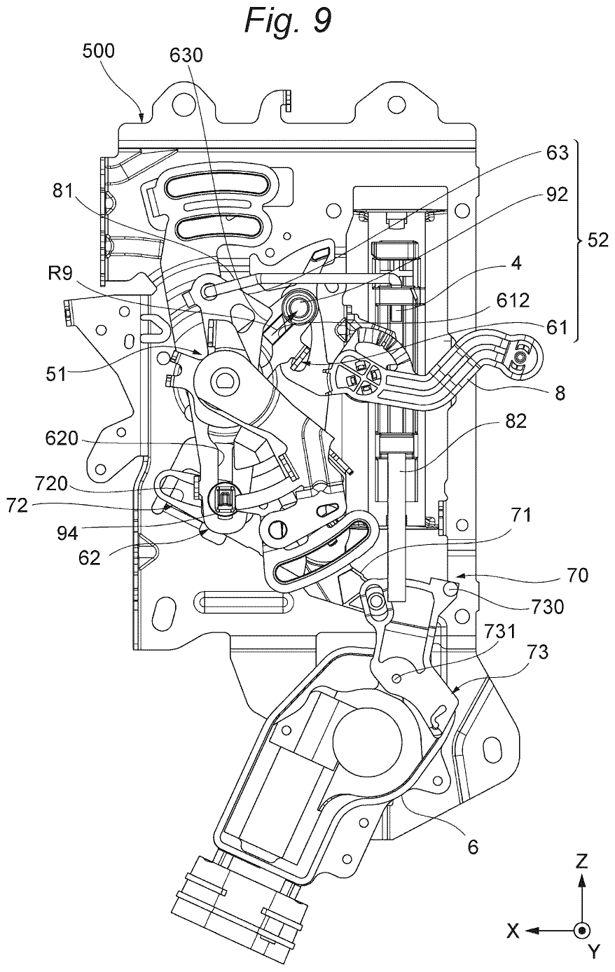

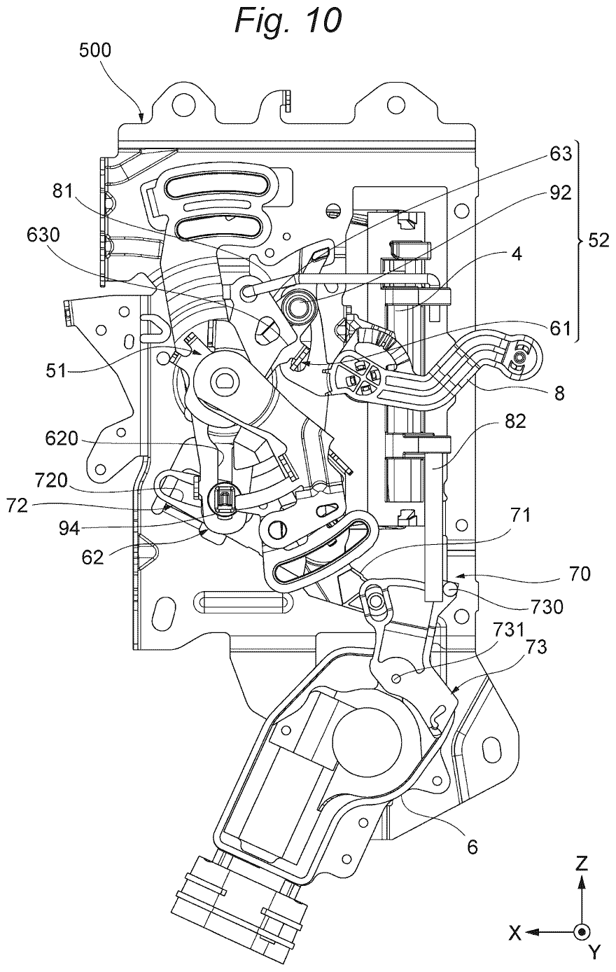

FIGS. 9 and 10 are explanatory views of the child protection mechanism 52 of the door latch mechanism 50, and are plan views as viewed from the vehicle exterior side. FIG. 9 illustrates the initial state of the door inside handle 4 in the locked state at the time of disabling-on, and FIG. 10 illustrates a state shifted from the state of FIG. 9, in which the first door opening operation has been performed (the pulled state of the door inside handle 4).

The child protection mechanism 52 functions in the locked state at the time of disabling-on (the locked state of the door when the child lock lever 8 is at the on-position).

The child protection mechanism 52 includes the first lever 61, the third lever 63, and the child protection pin 92.

The first lever 61 has a pin hole 612 through which the child protection pin 92 passes. The pin hole 612 has a form of a long hole (a form as viewed in the Y direction) in which the child protection pin 92 is movable. When the child lock lever 8 is at the off-position, the child protection pin 92 is at the initial position in the pin hole 612. Then, when the child lock lever 8 is operated from the off-position to the on-position, the child protection pin 92 reaches the operating position in the pin hole 612 (see an arrow R9 in FIG. 9).

As described above, in a case where the child protection pin 92 is at the initial position, when the third lever 63 is rotated to the operating position by the open link 81, the engaging portion 630 is engaged with the child protection pin 92 to rotate the first lever 61. On the other hand, in a case where the child protection pin 92 is at the operating position, when the third lever 63 is rotated to the operating position by the open link 81, the engaging portion 630 is not engaged with the child protection pin 92. That is, in a case where the child protection pin 92 is at the operating position, when the third lever 63 is rotated to the operating position by the open link 81, the third lever 63 idles, and does not rotate the first lever 61 (FIG. 10).

In this manner, the child protection mechanism 52 can disable the door opening operation by the door inside handle 4 when the child lock lever 8 is at the on-position.

In the present embodiment, the door lock mechanism 70 includes an emergency unlock mechanism 90 that shifts the locked state of the door to the unlocked state on the basis of the first door opening operation by the door inside handle 4 in the locked state at the time of disabling-on.

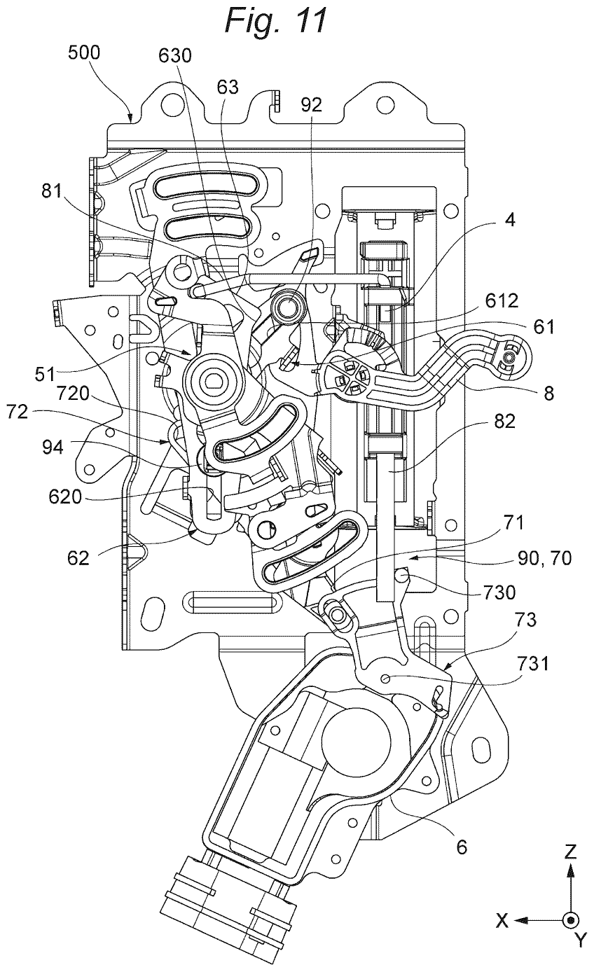

FIGS. 11 to 14 are explanatory views of the emergency unlock mechanism 90 of the door lock mechanism 70, and are plan views as viewed from the vehicle exterior side. Note that FIGS. 11 to 14 also illustrate some levers and the like not illustrated in FIGS. 5 to 8 described above.

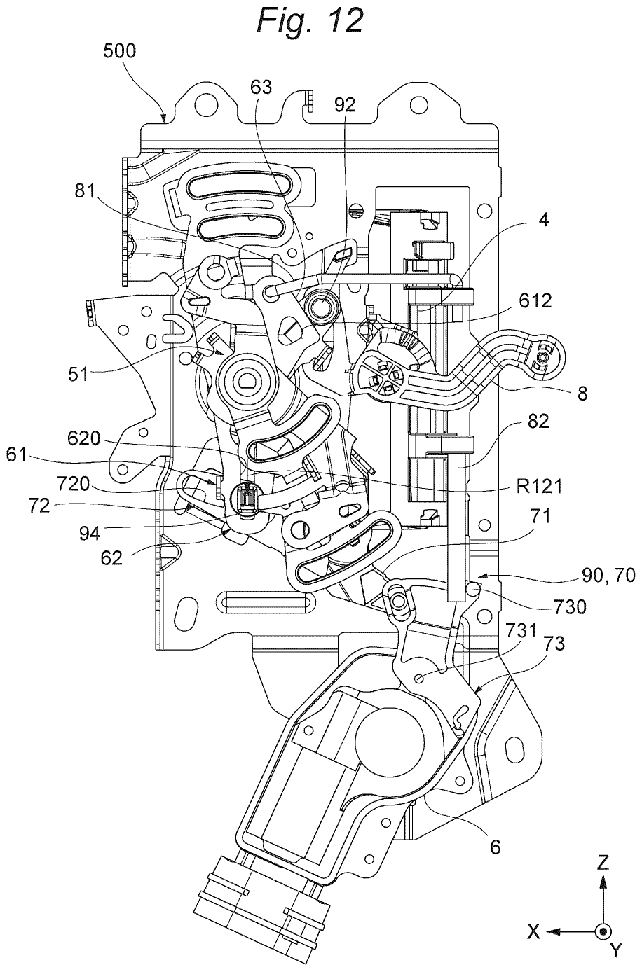

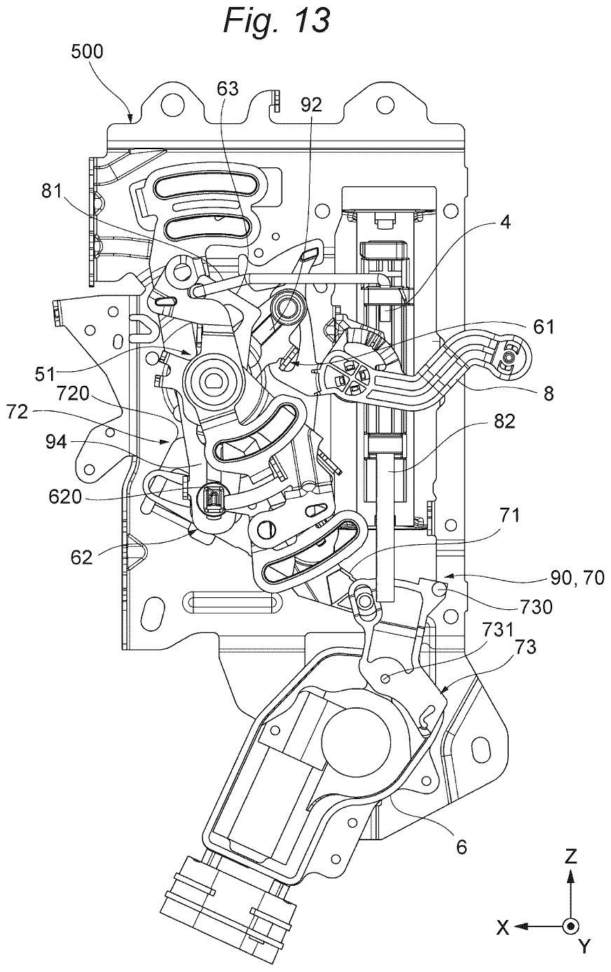

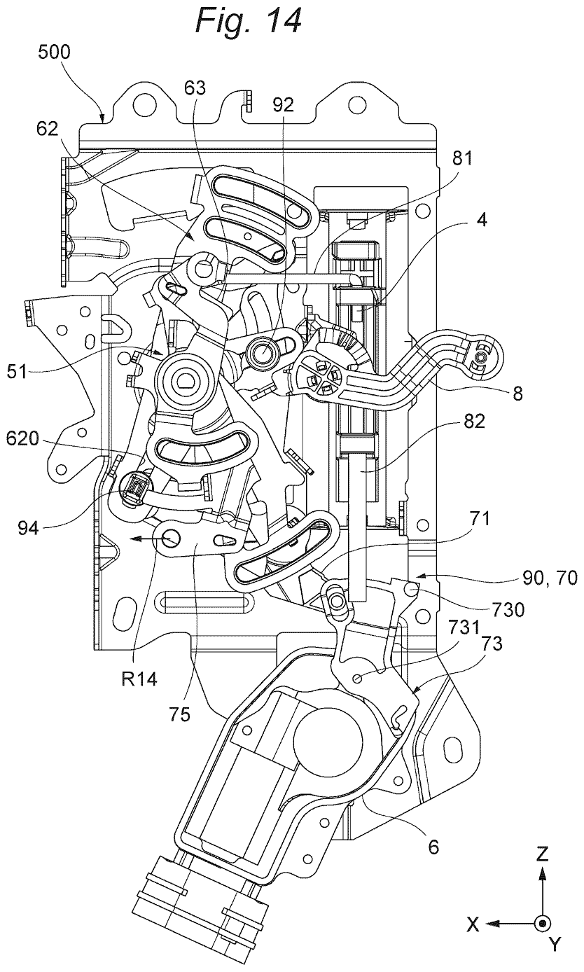

In FIGS. 11 to 14, FIG. 11 illustrates the initial state of the door inside handle 4 in the locked state at the time of disabling-on, and FIG. 12 illustrates a state shifted from the state of FIG. 11, in which the first door opening operation has been performed (the pulled state of the door inside handle 4). FIG. 13 illustrates a state shifted from the state of FIG. 12, which is an initial state where the door inside handle 4 is returned from the pulled state of FIG. 12. FIG. 14 illustrates a state shifted from the state of FIG. 13, in which the second door opening operation has been performed (the pulled state of the door outside handle 3).

Here, as described above, the door lock mechanism 70 cooperates with the double-pull mechanism 51, and shifts the locked state of the door to the unlocked state on the basis of the first door opening operation (and the returning operation inevitably following the first door opening operation) by the door inside handle 4 in the normal locked state.

In the present embodiment, the emergency unlock mechanism 90 of the door lock mechanism 70 shifts the locked state of the door to the unlocked state on the basis of the door opening operation by the door inside handle 4 even in the locked state at the time of disabling-on.

Specifically, first, in the state illustrated in FIG. 11 (the initial state of the door inside handle 4 in the locked state at the time of disabling-on), the door inside handle 4 is pulled to the pulled state (see FIG. 12) by the door opening operation. At this time, in the transmission path from the open link 81, the child protection pin 92 is at the operating position, and thus the first lever 61 does not rotate as described above. That is, the transmission path from the open link 81 is substantially disabled. On the other hand, in the transmission path from the transmission link 82, the force is transmitted to the transmission link 82, the actuator lever 73, the first panic lever 71, and the second panic lever 72 in this order, and the second panic lever 72 reaches the operating position. At this time, the longitudinal directions of the locking pin hole 610 of the first lever 61 and the locking pin hole 620 of the second lever 62 match each other. That is, the locking pin hole 610 of the first lever 61 and the locking pin hole 620 of the second lever 62 overlap each other as viewed in the Y direction. As a result, when the second panic lever 72 rotates, the locking pin 94 moves to the link position (see an arrow R121 in FIG. 12).

When the door inside handle 4 pulled to the pulled state by the door opening operation is returned to the original initial state (that is, when the returning operation is performed), the locking pin 94 returns to the link position as illustrated in FIG. 13. Note that, when the transmission link 82 returns to the original initial position, the actuator lever 73 does not receive the transmission of the force from the transmission link 82 and is maintained in the state (the state illustrated in FIG. 12).

In this manner, according to the present embodiment, by providing the emergency unlock mechanism 90, the unlocked state of the door can be formed on the basis of the door opening operation by the door inside handle 4 even in the locked state at the time of disabling-on. Note that, in the present embodiment, as described above, the transmission path from the transmission link 82 for moving the locking pin 94 to the link position is independent of the transmission path from the unlocked open link 81. As a result, it is possible to establish the emergency unlock mechanism 90 capable of forming the unlocked state of the door on the basis of the door opening operation by the door inside handle 4 regardless of the child protection mechanism 52 on the transmission path from the unlocked open link 81.

Meanwhile, in an emergency involving a power supply failure, the door handle actuator 10 does not operate, and thus the electric latch activation described above is disabled.

Therefore, in an emergency involving a power supply failure, it is useful to enhance the operability when the locked state of the door is mechanically shifted to the unlocked state by manual operation.

In this regard, according to the present embodiment, as described above, in the locked state at the time of disabling-on, the unlocked state of the door can be formed on the basis of the door opening operation by the door inside handle 4. As a result, in an emergency involving a power supply failure, it is possible to effectively enhance the operability when the locked state of the door is mechanically shifted to the unlocked state by manual operation.

Note that, in the present embodiment, since the child lock lever 8 is still at the on-position in the state illustrated in FIG. 14, the door latch is not opened even if the door inside handle 4 is brought into the pulled state as the second door opening operation. However, according to the present embodiment, the door latch can be opened from the outside of the vehicle, and it is possible to rescue an occupant.

Specifically, the door outside handle 3 is pulled to the pulled state as the door opening operation from the outside of the vehicle. In this case, the door latch is opened since the door outside handle 3 is pulled to the pulled state in the unlocked state. Specifically, the force is transmitted to the cable (not illustrated, see an arrow R14 in FIG. 14) from the door outside handle 3, the fifth lever 75, the locking pin 94, and the second lever 62 in this order, and the second lever 62 rotates to the operating position.

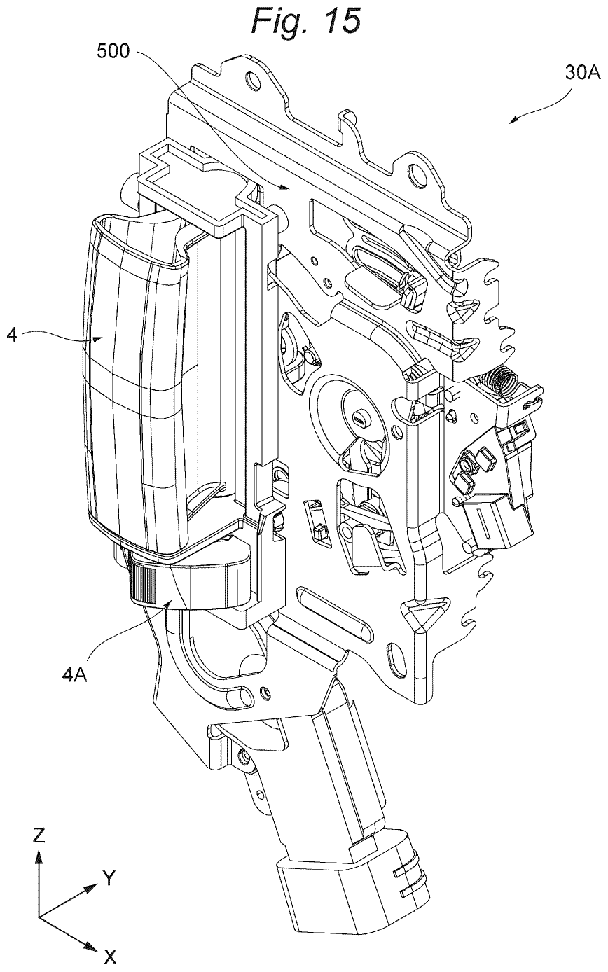

Next, another embodiment that may be implemented instead of the embodiment described above will be described with reference to FIG. 15 and subsequent drawings. Hereinafter, for the sake of distinction, the embodiment described above is also referred to as “first embodiment”, and another embodiment to be described below is also referred to as “second embodiment”. In the following description of the second embodiment, components that may be similar to those in the first embodiment described above are denoted by the same reference numerals, and description thereof may be omitted.

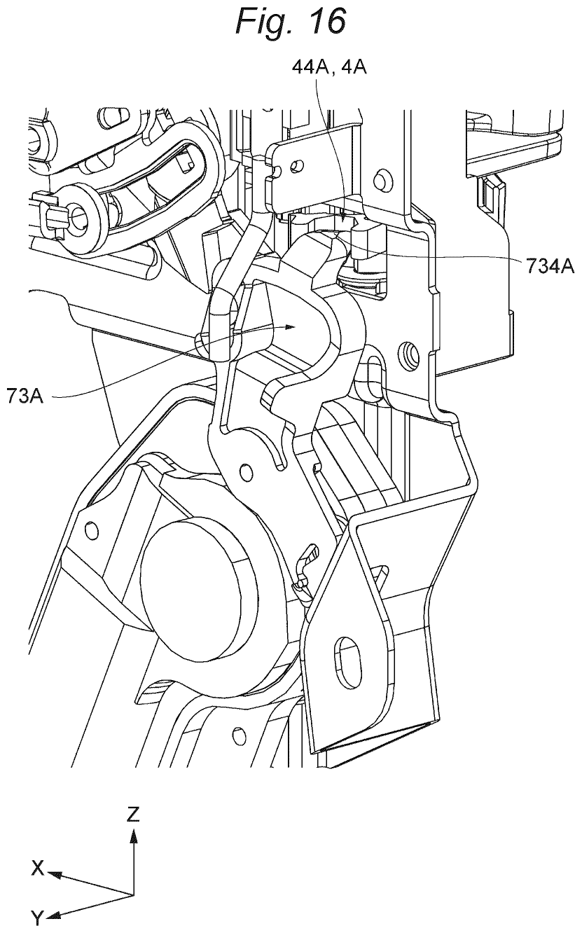

FIG. 15 is a view illustrating a door latch device 30A according to the second embodiment, and is a plan view as viewed from the vehicle interior side. FIG. 16 is a perspective view illustrating a relationship between a lock knob 4A and an actuator lever 73A in the door latch device 30A according to the second embodiment.

The door latch device 30A according to the present embodiment is mainly different from the door latch device 30 according to the first embodiment described above in that the lock knob 4A is additionally provided as a door locking operating member. In addition, the door latch device 30A according to the present embodiment is mainly different from the door latch device 30 according to the first embodiment described above in that the actuator lever 73 is replaced by the actuator lever 73A.

The lock knob 4A is a member that can be operated in a vehicle interior, and is provided so as to be exposed in the vehicle interior. The lock knob 4A may be provided at any place, but is preferably provided in the vicinity of the door inside handle 4, and is provided below the door inside handle 4 as an example in the present embodiment.

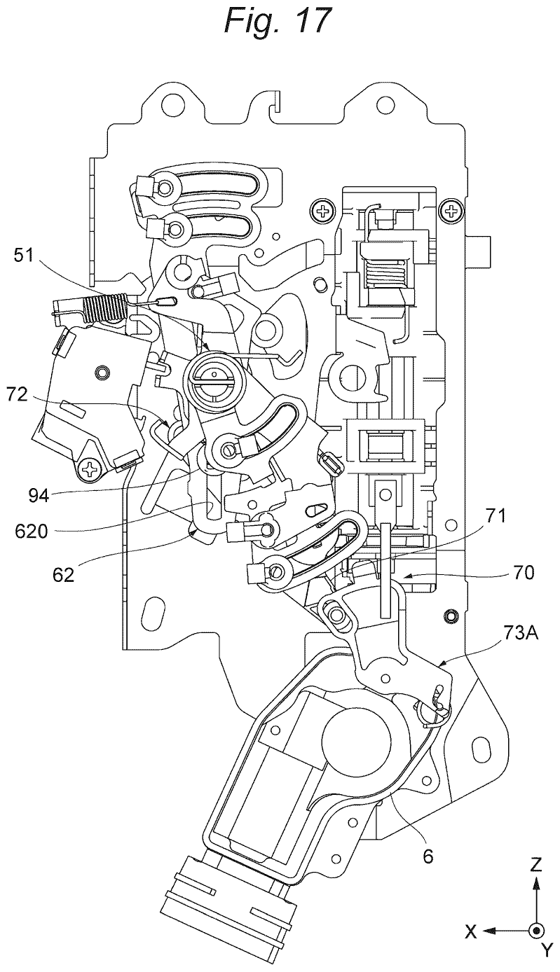

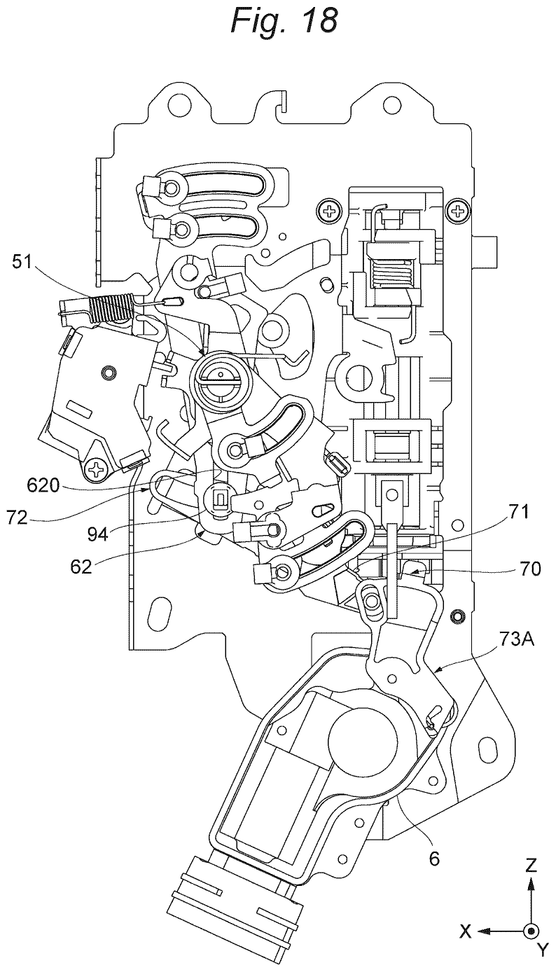

The lock knob 4A is supported by the support member 500 so as to be rotatable about a rotation axis in the up-down direction. In this case, the lock knob 4A is rotatable between a locked position (see FIG. 17) and an unlocked position (see FIG. 18), which will be described later. Here, in a modification, the lock knob 4A may be a sliding operating member or a push-button operating member.

The actuator lever 73A is different from the actuator lever 73 according to the first embodiment described above in that the actuator lever 73A is engaged with the lock knob 4A as described later. Other configurations of the actuator lever 73A (for example, the relationship with the door lock actuator 6 and the first panic lever 71) may be similar to those of the actuator lever 73 according to the first embodiment described above.

The lock knob 4A is mechanically connected to the actuator lever 73A. As illustrated in FIG. 16, the lock knob 4A may have a recess 44A that receives a protrusion 734A of the actuator lever 73A, and may be engaged with the actuator lever 73A through fitting of the protrusion 734A and the recess 44A (fitting in a direction perpendicular to the Z direction). The engagement mode between the lock knob 4A and the actuator lever 73A is not limited to such fitting, and may be any mode as long as the actuator lever 73A can be in conjunction with the movement (rotation in the present embodiment) of the lock knob 4A.

FIG. 17 is an explanatory view illustrating the door latch device 30A according to the second embodiment, and is a plan view of a locked state as viewed from the vehicle exterior side. FIG. 18 is an explanatory view illustrating the door latch device 30A according to the second embodiment, and is a plan view of an unlocked state as viewed from the vehicle exterior side. Note that, in FIGS. 17 and 18, some mechanisms of the door latch device 30 illustrated in FIG. 5 and the like are not illustrated, but it does not mean the absence of such mechanisms.

The lock knob 4A rotates the actuator lever 73A in a manner similar to that of the door lock actuator 6. The lock knob 4A operates to switch between the locked state and the unlocked state of the door via the actuator lever 73A in a manner similar to that of the door lock actuator 6. That is, when the lock knob 4A is at the locked position, the locked state of the door is formed, and when the lock knob 4A is at the unlocked position, the unlocked state of the door is formed.

Specifically, the lock knob 4A moves the locking pin 94 between a link position and a link cut position via the actuator lever 73A, the first panic lever 71, and the second panic lever 72. That is, when the lock knob 4A changes from the locked position to the unlocked position, the actuator lever 73A rotates, and in conjunction therewith, the locking pin 94 reaches the link position of the locking pin hole 620 of the second lever 62 via the first panic lever 71 and the second panic lever 72, and the unlocked state is formed (see FIG. 16). Conversely, when the lock knob 4A changes from the unlocked position to the locked position, the actuator lever 73A rotates, and in conjunction therewith, the locking pin 94 reaches the link cut position of the locking pin hole 620 of the second lever 62 via the first panic lever 71 and the second panic lever 72, and the locked state is formed (see FIG. 17).

Similar effects to those of the first embodiment described above are also obtained in the second embodiment. In particular, according to the second embodiment, in an emergency involving a power supply failure, the locked state and the unlocked state can also be switched by operating the lock knob 4A.

Although each embodiment has been described in detail above, the present disclosure is not limited to a specific embodiment, and various modifications and changes can be made within the scope described in the claims. In addition, all or a plurality of the components of the embodiments described above can be combined.

In one aspect, there is provided a vehicle door device mechanically connected to an inside handle and an outside handle of a vehicle door, the vehicle door device including:
a locking operating member configured to be movable between an on-position and an off-position;
a door latch mechanism mechanically connected to the inside handle, the outside handle, and the locking operating member; and
a door lock mechanism mechanically connected to the inside handle and configured to be able to selectively form a first door locked state when the locking operating member is at the off-position and a second door locked state when the locking operating member is at the on-position, in which
the door latch mechanism includes
a first mechanism configured to open a door latch on a basis of a series of two door opening operations by the inside handle in the first door locked state, and
a second mechanism configured to disable a door opening operation by the inside handle in the second door locked state, and
the door lock mechanism includes a third mechanism configured to form an unlocked state of a door on a basis of a door opening operation by the inside handle in the second door locked state.

In one aspect, according to the present disclosure, it is possible to form the unlocked state on the basis of the door opening operation by the inside handle even at the time of a power supply failure and even in the on-state of the operation disabling mechanism while adopting the double-pull structure.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A vehicle door device mechanically connected to an inside handle and an outside handle of a vehicle door, the vehicle door device comprising:
a locking operating member configured to be movable between an on-position and an off-position;
a door latch mechanism mechanically connected to the inside handle, the outside handle, and the locking operating member; and
a door lock mechanism mechanically connected to the inside handle and configured to be able to selectively form a first door locked state when the locking operating member is at the off-position and a second door locked state when the locking operating member is at the on-position, wherein the door latch mechanism includes a first mechanism configured to open a door latch on a basis of a series of two door opening operations by the inside handle in the first door locked state, and
a second mechanism configured to disable a door opening operation by the inside handle in the second door locked state, and
the door lock mechanism includes a third mechanism configured to form an unlocked state of a door on a basis of a door opening operation by the inside handle in the second door locked state.

2. The vehicle door device according to claim 1, wherein when the locking operating member is at an on-position, the third mechanism is mechanically disconnected from the first mechanism by the second mechanism.

3. The vehicle door device according to claim 1, wherein
the first mechanism includes a first link on a side closest to the inside handle in a force transmission path of the first mechanism, and
the third mechanism includes a second link on a side closest to the inside handle in a force transmission path of the third mechanism.

4. The vehicle door device according to claim 2, wherein
the first mechanism includes a first link on a side closest to the inside handle in a force transmission path of the first mechanism, and
the third mechanism includes a second link on a side closest to the inside handle in a force transmission path of the third mechanism.

5. The vehicle door device according to claim 3, wherein
the door lock mechanism includes a door lock actuator,
a locking pin positioned at a first position in the first door locked state and the second door locked state and positioned at a second position in the unlocked state, and
an actuator lever located between the door lock actuator and the locking pin, the actuator lever being configured to change the locking pin between the first position and the second position on a basis of an output from the door lock actuator, and
the second link changes the locking pin from the first position to the second position via the actuator lever on a basis of a door opening operation by the inside handle in the first door locked state and the second door locked state.

6. The vehicle door device according to claim 4, wherein
the door lock mechanism includes a door lock actuator,
a locking pin positioned at a first position in the first door locked state and the second door locked state and positioned at a second position in the unlocked state, and
an actuator lever located between the door lock actuator and the locking pin, the actuator lever being configured to change the locking pin between the first position and the second position on a basis of an output from the door lock actuator, and
the second link changes the locking pin from the first position to the second position via the actuator lever on a basis of a door opening operation by the inside handle in the first door locked state and the second door locked state.

7. The vehicle door device according to claim 5, further comprising a door locking operating member mechanically connected to the actuator lever and configured to be movable between a locked position and an unlocked position, wherein
when the door locking operating member changes from the locked position to the unlocked position, the door locking operating member changes the locking pin from the first position to the second position via the actuator lever, and when the door locking operating member changes from the unlocked position to the locked position, the door locking operating member changes the locking pin from the second position to the first position via the actuator lever.

8. The vehicle door device according to claim 6, further comprising a door locking operating member mechanically connected to the actuator lever and configured to be movable between a locked position and an unlocked position, wherein
when the door locking operating member changes from the locked position to the unlocked position, the door locking operating member changes the locking pin from the first position to the second position via the actuator lever, and when the door locking operating member changes from the unlocked position to the locked position, the door locking operating member changes the locking pin from the second position to the first position via the actuator lever.
